(19) United States
(12) Patent Application Publication
(10) Pub. No.: US 2015/0362759 A1
(43) Pub. Date: Dec. 17, 2015

(54) ILLUMINATED EYEWEAR

(71) Applicants: Kristine Verkaik, Eustis, FL (US); Daryl Verkaik, Eustis, FL (US)

(72) Inventors: Kristine Verkaik, Eustis, FL (US); Daryl Verkaik, Eustis, FL (US)

(21) Appl. No.: 14/741,047

(22) Filed: Jun. 16, 2015

Related U.S. Application Data
(60) Provisional application No. 62/013,057, filed on Jun. 17, 2014.

(51) Int. Cl. G02C 11/00; G02C 11/02; F21V 5/04; F21V 23/04; F21V 33/00; F21V 23/00

(52) U.S. Cl. CPC G02C 11/10; F21V 33/0008; F21V 23/003; F21V 5/04; F21V 23/0435; F21V 23/0471; G02C 11/02; F21Y 2101/02

(57) ABSTRACT

An apparatus for eyewear comprises a light emitter, a temple having an interior side opposing an exterior side, an aperture disposed on the temple and aligned with the light emitter, a control unit having a first side opposing a second side, wherein the light emitter is affixed to the first side and the first side is affixed to the temple, and a processor affixed to the control unit and in electronic communication with the light emitter.

### RELATED APPLICATIONS

This application is related to and claims the benefit of U.S. Provisional Patent Application Ser. No. 62/013,057 titled ILLUMINATED EYEWEAR filed on Jun. 17, 2014, the entire contents of which are incorporated herein by reference.

### FIELD OF THE INVENTION

The present invention relates to the field of eyewear. More specifically, the present invention relates to eyewear that includes ornamental light emitters and controllers.

### BACKGROUND

Eyeglasses have traditionally been used to correct the vision of the wearer. The wearing of eyewear can be stigmatizing for certain people and affect their appearance. Some individuals may be reluctant to wear eyewear due to the perceived image of those who wear eyeglasses. Some people may choose to forgo the wearing of corrective lenses out of vanity and to their own detriment.

As a result, there exists a need for eyewear that encourages a wearer to don the apparatus. There additionally exists a need for eyewear that is visually attractive and creates a positive impression on those wearing it and those who view the wearer of the eyewear.

### SUMMARY OF THE INVENTION

With the foregoing in mind, embodiments of the present invention are related to eyewear that incorporates LEDs or other energy efficient light emitters. Furthermore, the eyewear may advantageously combine energy efficient light emitters and a controller to illuminate the light emitters in a visually pleasing, and not distracting, manner.

These and other features and advantages according to an embodiment of the present invention are provided by an eyeglass frame in combination with efficient light emitters and a control unit. The control unit may be mounted into a hollowed out portion on the temple of the eyeglass frame. The control unit may have light emitters mounted to the unit. The light emitters may align with apertures disposed in the eyeglass frame temple when the control unit is mounted in the temple. The control unit may incorporate a motion sensing component that activates the light emitters upon the detection of motion. The control unit may limit the frequency of illumination of the light emitters to preserve battery life of the apparatus and to prevent the illumination of the light emitters from being distracting to the wearer or those around the wearer. The illumination of the emitters may be controlled by the control unit to create desired visual effects. The light emitters may combine with a design on the external side of the temple to create an aesthetically pleasing appearance.

### BRIEF DESCRIPTION OF THE DRAWINGS

FIG. 1 depicts the first side of a control unit positioned on the interior side of a temple.

FIG. 2 depicts the exterior side of a temple.

FIG. 3 depicts the second side of a control unit.

FIG. 4 depicts the interior side of a temple with the control unit absent.

FIG. 5 depicts an embodiment of the illuminated eyewear apparatus with a remote control module.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

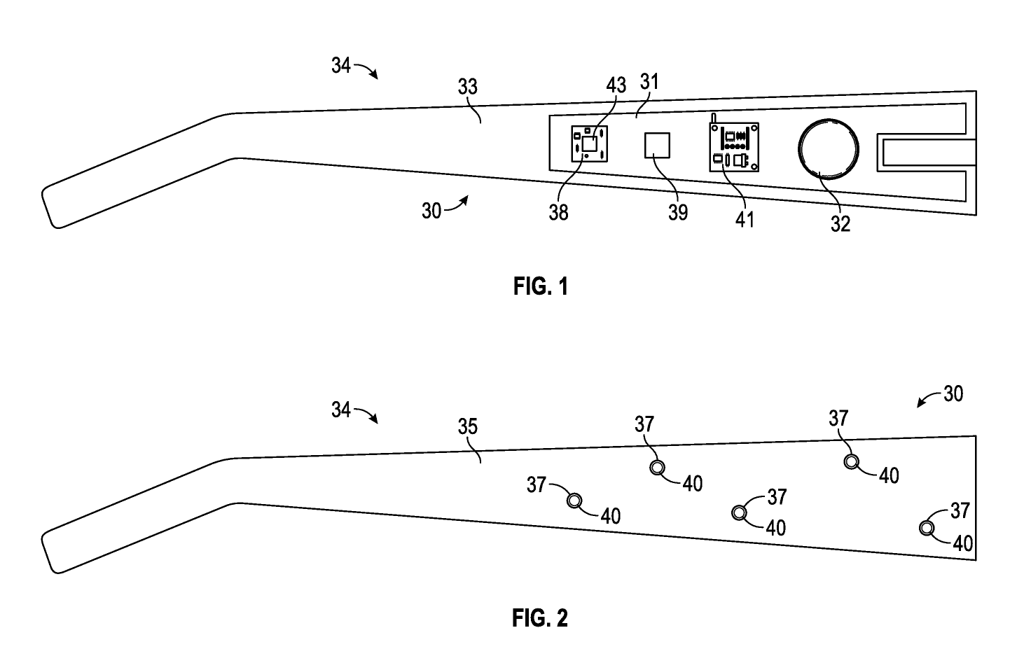

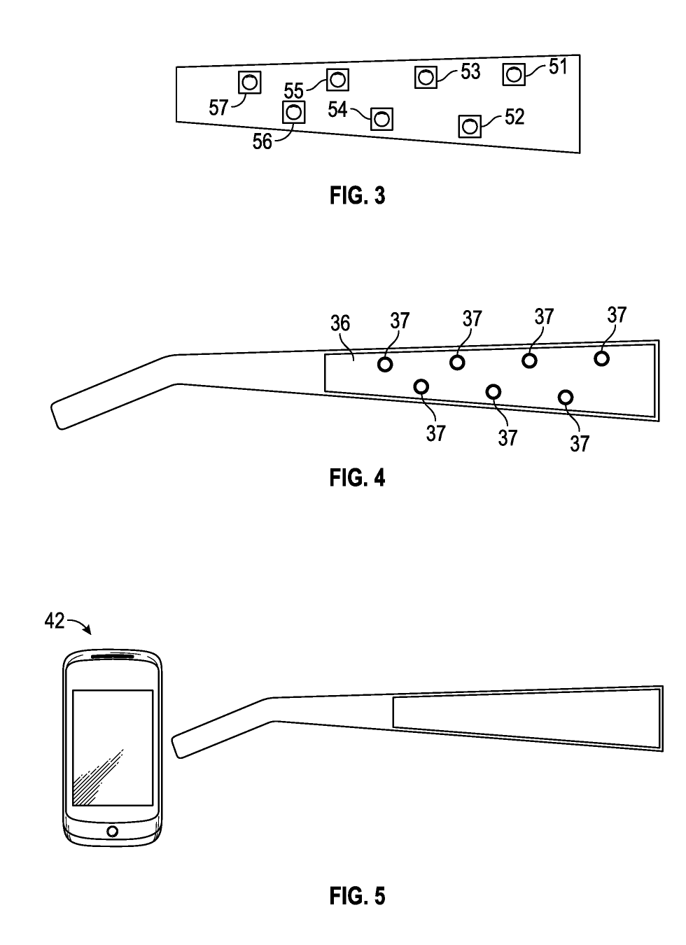

As depicted in FIG. 1, the light emitting eyewear may comprise a control unit 31 with a first side opposing a second side. The control unit 31 may be a PCB, flex circuit, or the like. The control unit 31 may have light emitters 51, 52, 53, 54, 55, 56, 57 physically connected to the control unit 31 and placed on the second side of the control unit 31. All other electronics may be placed on the first side of the control unit 31. The control unit may be mounted to the interior side 33 of an eyeglass frame temple 34. The temple 34 may have a control unit recess 36 which is configured to allow the placement of the control unit 31 partially or completely recessed within the interior side 33 of the temple 34 to lower the visible profile of the control unit.

The temple 34 may have at least one aperture 37 disposed within the control unit recess 36. When the control unit 31 is mounted within the control unit recess 36, the light emitters 51, 52, 53, 54, 55, 56, 57 may align with the apertures 37 to enable the light emitted by the light emitters 51, 52, 53, 54, 55, 56, 57 to be visible to an observer viewing the external side 35 of the temple. The apertures 37 may be covered with lenses to affect the appearance of the light emitted by the light emitters 51, 52, 53, 54, 55, 56, 57. The lens may refract or scatter the light. Additionally, the lens may alter the color of the light. There may be one or more lenses present on the apertures 37.

The control unit 31 may comprise at least one light emitter 51, 52, 53, 54, 55, 56, 57, a processor 38, a motion sensing device 39, and a battery unit 40. The motion sensing device 39 may be in electrical communication with the processor 38. The motion sensing device 39 may be an accelerometer. The motion sensing device 39 may send an electrical signal to the processor 38 when motion is detected. In one embodiment, the detected motion must be of a certain duration or intensity to be detected by the motion sensing device 39. The processor 38 may have an integrated light emitter control module 43 or the processor 38 may be in electrical communication with a light emitter control module 43. The light emitter control module 43 may receive an electrical signal from the motion sensing device 39. The light emitter control module 43 may enable at least one light emitter 51, 52, 53, 54, 55, 56, 57 based upon the signal received from the motion sensing device 39. In one embodiment, the light emitter control module 43 may enable at least one light emitter 51, 52, 53, 54, 55, 56, 57 for a limited period of time after motion has been detected. In one embodiment, the light emitter control module 43 may enable at least on light emitter 51, 52, 53, 54, 55, 56, 57 only a limited number of times within a time window. By way of example, and not as a limitation, the light emitter control module 43 may activate the light emitter 51, 52, 53, 54, 55, 56, 57 when motion is detected, but not if the light emitter 51, 52, 53, 54, 55, 56, 57 has previously been activated within a time window, which may be, by way of example, and not a limitation, five minutes long. In such an embodiment, the light emitter 51, 52, 53, 54, 55, 56, 57 could be activated at most only once every five minutes. In another embodiment, by way of example, and not as a limitation, the time window may be twenty minutes long. In such an embodiment, the at least one light emitter 51, 52, 53, 54, 55, 56, 57 could be activated at most once every twenty minutes.

A wireless transceiver 41 may be disposed on the control unit 31 and in electronic communication with the processor 38 and a remote control module 42.

In one embodiment, there may be a plurality of light emitters 51, 52, 53, 54, 55, 56, 57 controlled by light emitter control module 43. In such an embodiment, the light emitters 51, 52, 53, 54, 55, 56, 57 may be activated relative to one another. The light emitter control module 43 may activate a first light emitter 51 based on a control signal received from the motion sensing device 39. The second light emitter 52 may be activated a predetermined amount of time after activation of the first light emitter 51. A third light emitter 53 may be activated a predetermined amount of time after activation of the second light emitter 52. Additional light emitters 54, 55, 56, 57 may be activated accordingly. Each light emitter 51, 52, 53, 54, 55, 56, 57 may be activated for a predetermined amount of time. Each light emitter 51, 52, 53, 54, 55, 56, 57 may be activated for the same, different, or a combination of same and different amounts of time.

The light emitters 51, 52, 53, 54, 55, 56, 57 may be disposed on the control unit 31 to align with apertures 37 in the frame temple 34. The light emitters 51, 52, 53, 54, 55, 56, 57 may be disposed in a configuration that creates an aesthetically pleasing image when they are activated sequentially by the control unit 31. In one embodiment, the light emitters 51, 52, 53, 54, 55, 56, 57 may be disposed in a row with the first light emitter 51 in front of all of the other light emitters 52, 53, 54, 55, 56, 57. If there are N light emitters, the Nth light emitter may be the last in the line, the N−1 light emitter may precede the N light emitter. The control unit 31 may activate the light emitters 51, 52, 53, 54, 55, 56, 57 in order from 1 to N. There may be a period of time when more than one light emitter 51, 52, 53, 54, 55, 56, 57 is activated by the control unit 31. By way of example and not as a limitation, in an embodiment where N=7, the control unit may control the light emitters 51, 52, 53, 54, 55, 56, 57 to illuminate in a schedule as follows:
Activate light emitter 51
Activate light emitter 52
Activate light emitter 53
Deactivate light emitter 51
Activate light emitter 54
Deactivate light emitter 52
Activate light emitter 55
Deactivate light emitter 53
Activate light emitter 56
Deactivate light emitter 54
Activate light emitter 57
Deactivate light emitter 55
Deactivate light emitter 56
Deactivate light emitter 57

By way of another example and not as a limitation, in an embodiment where N=7, the control unit may control the light emitters 51, 52, 53, 54, 55, 56, 57 to illuminate in a schedule as follows:
Activate light emitter 51
Activate light emitter 52
Activate light emitter 53
Simultaneously deactivate light emitter 51 and activate light emitter 54
Simultaneously deactivate light emitter 52 and activate light emitter 55
Simultaneously deactivate light emitter 53 and activate light emitter 56
Simultaneously deactivate light emitter 54 and activate light emitter 57
Deactivate light emitter 55
Deactivate light emitter 6
Deactivate light emitter 7

By way of another example and not as a limitation, in an embodiment where N=7, the control unit may control the light emitters to illuminate in a schedule 51, 52, 53, 54, 55, 56, 57 as follows:
Activate light emitter 51
Activate light emitter 57
Simultaneously deactivate light emitter 51, deactivate light emitter 57, activate light emitter 52, and activate light emitter 56
Simultaneously deactivate light emitter 52, deactivate light emitter 56, activate light emitter 53, and activate light emitter 55
Simultaneously deactivate light emitter 53, deactivate light emitter 55, and activate light emitter 54
Deactivate light emitter 54

One skilled in the art will appreciate that the above activation schedules are exemplary and many other possible combinations are available.

Light emitters 51, 52, 53, 54, 55, 56, 57 may be activated by the light emitter control module 43 or processor 38 to illuminate in different colors, intensities, durations, frequencies, timing, or the like. The specific illumination routine, including the colors, intensities, durations, frequencies, and timing of illumination of each light emitter 51, 52, 53, 54, 55, 56, 57 may be referred to as a schedule. The illuminated eyewear apparatus 30 may contain one or more pre-programmed schedules. The schedules may be programmable. In one embodiment, a remote control module 42 may be utilized to program, select, modify, or create the schedules. The remote control module 42 may affect the schedules by wirelessly communicating with the wireless transceiver 41. In one embodiment, the wireless transceiver 41 or remote control module 42 may implement Bluetooth® technology.

A user may access an application on a smart phone, computer, tablet, or the like to program, select, modify, or create the schedules. The desired schedule may be wirelessly transmitted to the illuminated eyewear apparatus 30, where it may be executed by the light emitters 51, 52, 53, 54, 55, 56, and 57. In some embodiments, the desired schedule may be transmitted to the illuminated eyewear apparatus 30 using a wired system.

The illuminated eyewear apparatus 30 may be powered by a battery 32 mounted to the control unit 31. In some embodiments, the battery 32 may be replaceable. In some embodiments, the battery 32 may be rechargeable utilizing a charging connector integrated into the control unit 31. In such an embodiment, the battery 32 may be recharged by physically connecting the illuminated eyewear apparatus 30 to a power supply using conventional connection methods, including, but not limited to, a USB connection. In some embodiments, the battery 32 may be affixed to the control unit 31 in a location to facilitate wireless charging or charging through inductance. Such an embodiment may remove the need to have physical connector for a charger and may allow the battery 32 to charge through contact with or proximity to an inductive charging device.

The light emitters 51, 52, 53, 54, 55, 56, 57 may be LEDs. The light emitters 51, 52, 53, 54, 55, 56, 57 may be potted into control unit 31.

The control unit 31 may be mounted in the control unit recess 36 using a permanent mounting method, such as, by way of example, and not as a limitation, epoxy, glue, or the like. In one embodiment, the control unit 31 may be mounted in the control unit recess 36 using a mounting mechanism that may allow the control unit 31 to be removed and replaced. In such an embodiment, the control unit 31 may be secured to the temple 34, by way of example, and not as a limitation, using screws, fasteners, or the like.

The control unit 31 may comprise a control switch. The control switch may be activated to allow the light emitters 51, 52, 53, 54, 55, 56, 57 to illuminate and it may be deactivated to prevent the light emitters 51, 52, 53, 54, 55, 56, 57 from illuminating. Such a control switch may be beneficial in environments in which it may be undesirable for the light emitters 51, 52, 53, 54, 55, 56, 57 to illuminate.

The battery 32 may be disposable. In such an embodiment, the battery 32 may be accessible without removing the control unit 31 from the temple 34. An access piece may be removed from the control unit 31 to allow the battery 32 to be removed and replaced. After replacement of the battery 32, the access piece may be reinserted or reaffixed to the control unit 31.

The foregoing examples have been provided in the interest of clarity to illustrate an embodiment of the present invention in substantial detail. A person of skill in the art will appreciate that one or more of the above provided embodiments may be included in the operation of the illuminated eyewear of the present invention. Additionally, a person of skill in the art will appreciate additional embodiments that would be included within the scope and spirit of the present invention, after having the benefit of this disclosure. Furthermore, a skilled artisan will appreciate that the operations described above, along with additional operations that would be apparent to those in the art, may be performed exclusively, incrementally, sequentially, simultaneously, or any other operative configuration.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. An apparatus for eyewear comprising:
a light emitter;
a temple having an interior side opposing an exterior side;
an aperture disposed on the temple and aligned with the light emitter;
a control unit having a first side opposing a second side, wherein the light emitter is affixed to the first side and the first side is affixed to the temple; and
a processor affixed to the control unit and in electronic communication with the light emitter.

2. The apparatus of claim 1 wherein the light emitter is potted with the control unit.

3. The apparatus of claim 1 wherein the processor is affixed to the second side of the control unit.

4. The apparatus of claim 1 wherein the control unit is affixed to the interior side of the temple.

5. The apparatus of claim 1 wherein the temple further comprises a control unit recess disposed on the interior side of the temple and adjacent to the aperture.

6. The apparatus of claim 1 further comprising:
a lens covering the aperture.

7. The apparatus of claim 1 further comprising:
a wireless transceiver affixed to the control unit and in electronic communication with the processor.

8. The apparatus of claim 7 further comprising:
a remote control module in wireless communication with the wireless transceiver, wherein the remote control module further comprises a color variable that is transmitted to the processor.

9. The apparatus of claim 7 further comprising:
a remote control module in wireless communication with the wireless transceiver, wherein the remote control module further comprises a duration variable that is transmitted to the processor.

10. The apparatus of claim 1 further comprising:
a motion sensing device in electronic communication with the processor; and
a light emitter control module, in electronic communication with the light emitter and the motion sensing module, that activates the light emitter when the motion sensing module detects motion.

11. The apparatus of claim 10 wherein the light emitter control module activates the light emitter when the motion sensing device detects motion over a threshold.

12. The apparatus of claim 11 wherein the threshold comprises a duration.

13. The apparatus of claim 10 wherein the light emitter control module limits activation of the light emitter within a time window.

14. The apparatus of claim 1 further comprising:
a plurality of light emitters affixed sequentially to the first side of the control unit;
a plurality of apertures disposed on the temple, each of the plurality of apertures aligned with one of the plurality of light emitters; and
a light emitter control module in electronic communication with each of the plurality of light emitters, wherein the light emitter control module sequentially activates each of the plurality of light emitters.

15. An apparatus for eyewear comprising:
a plurality of light emitters;
a control unit having a first and second side, wherein the plurality of light emitters are affixed to the first side;
a temple having an inside and an outside, wherein the temple further comprises a control unit recess disposed on the interior side of the temple and the control unit is affixed to the interior side of the temple adjacent to the control unit recess;
a plurality of apertures disposed on the temple adjacent to the control unit recess wherein each of the plurality of apertures is aligned with one of the plurality of light emitters; and
a processor affixed to the control unit and in electronic communication with each of the plurality of light emitters.

16. The apparatus of claim 15 further comprising:
a plurality of lens wherein each of the plurality of lens cover one of the plurality of apertures.

17. The apparatus of claim 15 further comprising:
a light emitter control module in electronic communication with the plurality of light emitters, wherein the plurality of light emitters are sequentially affixed to the first side of the control unit and sequentially activated by the control module.

18. The apparatus of claim 17 further comprising:
a wireless transceiver affixed to the control unit and in electronic communication with the light emitter control module.

19. The apparatus of claim 18 further comprising:
a control module in wireless communication with the wireless transceiver, wherein the control module further comprises a duration variable that is transmitted to the light emitter control module.

20. An apparatus for eyewear comprising:
a plurality of light emitters;
a control unit having a first opposing a second side, wherein the plurality of light emitters are affixed to the first side;
a temple having an interior side and an exterior side, wherein the temple further comprises a control unit recess disposed on the interior side of the temple and the control unit is affixed to the interior side of the temple adjacent to the control unit recess;
a plurality of apertures disposed on the temple adjacent to the control unit recess wherein each of the plurality of apertures is aligned with one of the plurality of light emitters;
a wireless transceiver affixed to the second side of the control unit;
a light emitter control module in electronic communication with the plurality of light emitters and the wireless transceiver; and
a control module in wireless communication with the wireless transceiver, wherein the control module further comprises a duration variable that is transmitted to the processor.
